(19) United States
(12) Patent Application Publication
(10) Pub. No.: US 2005/0183299 A1
(43) Pub. Date: Aug. 25, 2005

(54) Decoration with visual effects

(76) Inventor: Kevin Lee, Taipei (TW)

Correspondence Address: Kevin Lee, PO Box 82-144, Taipei, TW

(21) Appl. No.: 10/781,742

(22) Filed: Feb. 20, 2004

(51) Int. Cl. G09F 19/00

(52) U.S. Cl. 40/406; 40/409

(57) ABSTRACT

A decoration with visual effects comprised of base, transparent cover, light permeable solid wax and transparent liquid; the cover provided a closed space to contain the liquid; the liquid containing the wax and sequins; the base at the bottom of the cover containing a heat source and a color light source; the liquid being heated to create convection for sequins to float around; wax being divided into multiple pieces; each floating piece of wax giving consistent and atomized light permeability; and the color light source projecting the light into the cover for floating pieces of the wax to present combination of colors and light with beautiful visual effect.

### BACKGROUND OF THE INVENTION

(a) Technical Field of the Invention

The present invention is related to a decoration with visual effects, and more particularly, to a closed and transparent container, with a heat source causing the liquid in the container to have convection to further drive the separation of wax and enabling sequins to float, light is then projected on the flowing wax to create dynamic, visual effects in combination of light and colors by taking advantage of the consistent and atomized light permeability feature.

(b) Description of the Prior Art

As living standards improve, light decorations are becoming a necessity in upgrading one's living quality. Many diversified decorations featuring changing light emissions are generally available in the market. Among them, one of the most popular relates to a transparent container that contains colored or transparent liquid provided therein multiple minute, floating and reflective objects. A light source is provided by the container to generate heat and the heated liquid creates convection for those reflective objects to move around in the container, thus to create mobile visual effects as the reflective objects reflect the light projected on them in different directions.

Another decoration also relates to a transparent container filled up with two types of liquid in different specific weight and color that are not solvable to each other. A light source and a heat source are provided to respectively project the light and the heat on the liquids for them to create convection for presenting special visual effects by taking advantage of the difference and variance of the light projected by both liquids.

However, in the highly competitive modern society, the life cycle of each type of commodities is getting shorter and can be easily eliminated in the absence of any specific and unique product feature. How to develop a unique decoration which satisfies consumer requirements is a topic of surviving in the trade.

### SUMMARY OF THE INVENTION

The primary purpose of the present invention is to provide an improved structure of a decoration with visual effects that feature the soft and mobile visual enjoyment of combination of colors and light. To achieve the purpose, a closed cover is filled up with transparent liquid and a sold wax and multiple sequins are distributed in the liquid. A base provided at the bottom of the cover contains a heat source and multiple light sources in different colors. Convection taking place to the fluid in the cover when projected with heat and weak light from the heat source causes the sequins to float around in the cover while the solid wax is divided into multiple pieces to also flow around in the cover. Since the solid wax gives consistent and atomized light permeability, those multiple pieces of solid wax and sequins project the light emission in different colors to create the visual effects.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is a schematic view showing the present invention as assembled.

FIG. 3 is a sectional view of the present invention as assembled.

FIG. 4 is a schematic view showing the present invention in operation.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

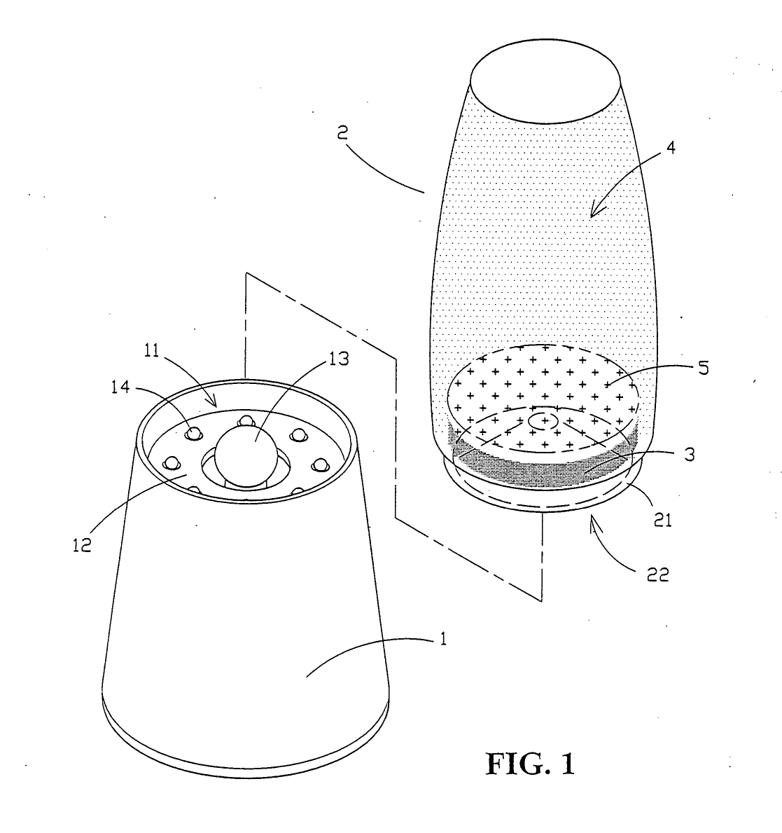

Referring to FIG. 1, a preferred embodiment of the present invention is essentially comprised of a base 1, a transparent cover 2, a light permeable solid wax 3, a transparent liquid 5 and multiple sequins 5. Wherein, a recess 11 is provided on the top of the base 1; a base plate 12 is inserted in the recess 11; a heat source 13 is disposed at the center of the base plate 12; and multiple light sources 14 in different colors are provided either on the peripheral to or by the heat source 13. The cover 2 relates to a closed space filled up with the transparent liquid 4 and those multiple sequins 5; a flange 21 is extended from the bottom of the cover 2 and a recess 22 is provided in the middle of the flange 21. The solid wax 3 has a specific weight slightly greater than that of the liquid 4 and always gets settled down at the bottom inside the cover 2 in normal status. Those sequins 5 are accumulated above the solid wax 3.

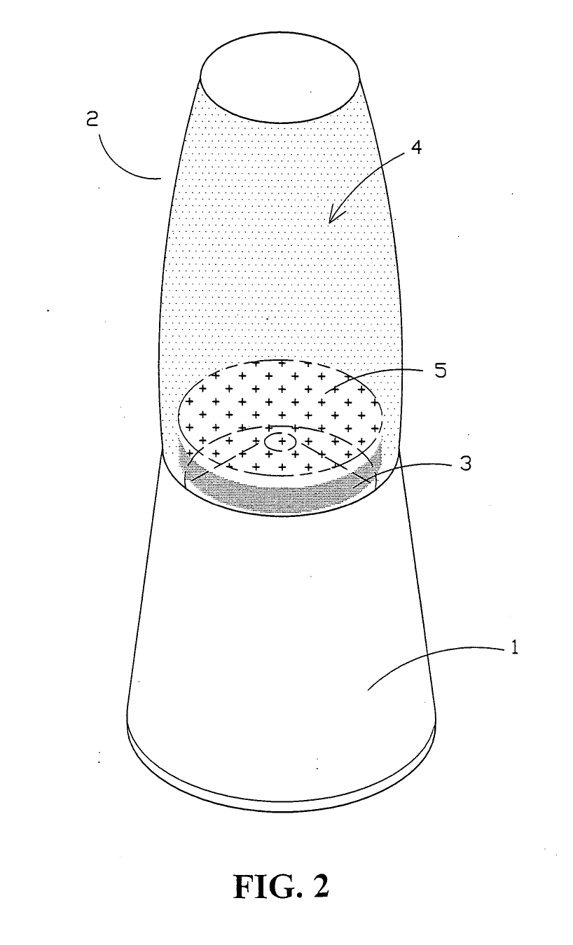

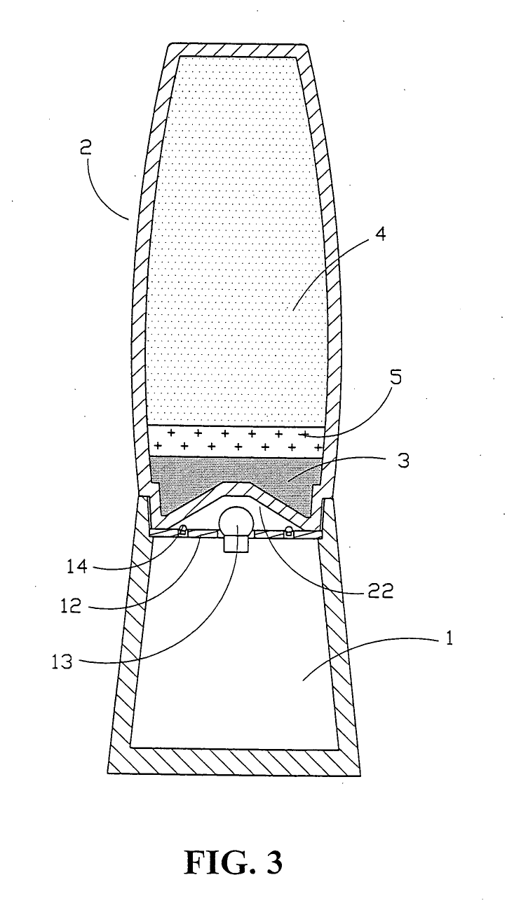

As illustrated in FIGS. 2 and 3, when the preferred embodiment is assembled, the cover 2 has its recess 22 to be inserted into the recess 11 in the base 1 so to couple the cover 2 to the base 1 with the heat source 13 protruding into the recess 22 of the cover 2 while those multiple color light sources 14 are respectively arranged on the peripheral to or by the heat source 13.

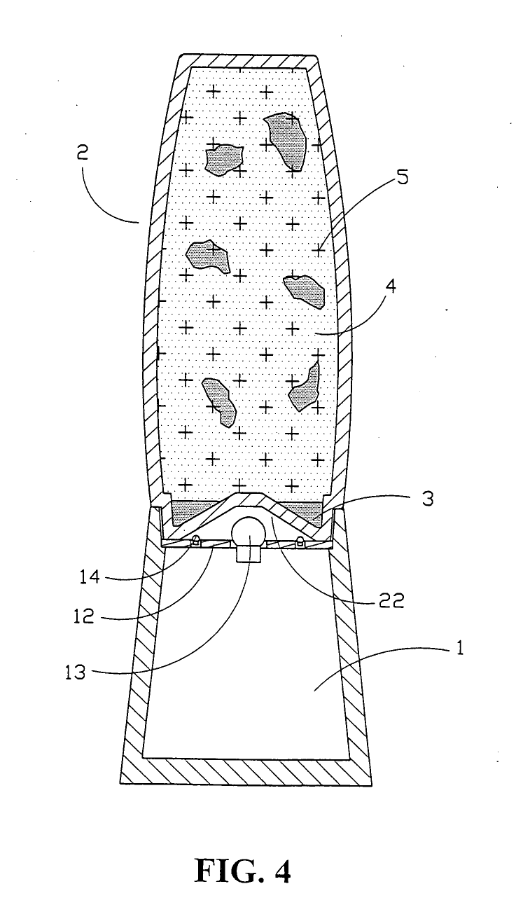

Now referring to FIG. 4, when the power is supplied to the heat source 13 and those color light sources 14 in the base 1, the liquid 4 in the cover 2 is heated to create convection for those multiple sequins to float around while the solid wax 3 is cracked into multiple pieces of suspended wax 31. Whereas the solid wax 3 has an inherited property of consistent and atomized light permeability, lights projected from those color light source 14 are consistently atomized and missed inside each piece of the suspended wax 31 to transmit the mixed light in different colors from those multiple suspended pieces of the wax (31) distributed at different locations in the cover 2 to present multi-color, multi-layer, ambiguous and dynamic visual effects in conjunction with the movement of those suspended pieces of the wax 31 by following the convection of the liquid 4.

The present invention by having multiple colors consistently mixed in a light-permeable solid wax and creating dynamic and versatile changes of visual effect is innovative and meeting the requirements set forth in patent laws. Therefore, this application is duly filed accordingly.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A decoration with visual effects comprised of a transparent cover to define a closed space filled up with a transparent liquid; a base provided at the bottom of the cover having at the center on its top disposed a heat source, and multiple color sources in different colors on the peripheral of the heat source; and a solid wax containing solid status oil wax in a specific weight slightly greater than that of the transparent liquid and settled down at the bottom in the cover in normal condition is characterized by that when the heat source being conducted, convection taking place in the liquid, the solid wax being cracked into multiple pieces suspending in the liquid, colors projected from those light sources being consistently atomized, mixed, and transmitted through each suspended pieces of the wax distributed at different locations in the convection of the liquid to create soft, dynamic, and attractive visual effects.

2. A decoration with visual effects as claimed in claim 1, wherein, a recess is provided on the top of the base, and a flange is provided at the bottom of the cover to be inserted into the recess of the base for the cover to be incorporated into the base.

3. A decoration with visual effects as claimed in claim 1, wherein, a recess is provided at the bottom of the cover to merely accommodate the light and the heat sources once the cover is incorporated into the base.
